(19) United States
(12) Patent Application Publication
(10) Pub. No.: US 2006/0210115 A1
(43) Pub. Date: Sep. 21, 2006

(54) System for, method of generating and organizing a warehouse database and using the database to provide and/or present required information

(75) Inventor: Yaron Nemet, Kedumim (IL)

Correspondence Address: RICHARD I. SAMUEL;GOODWIN PROCTER L.L.P, 599 LEXINGTON AVE., NEW YORK, NY, 10022, US

(73) Assignee: ImageID

(21) Appl. No.: 11/365,161

(22) Filed: Mar. 1, 2006

Related U.S. Application Data
(60) Provisional application No. 60/657,661, filed on Mar. 1, 2005.

(51) Int. Cl. G06K 9/00; H04N 7/18

(52) U.S. Cl. 382/104; 348/113

(57) ABSTRACT

A system is disclosed for generating a warehouse database containing information relating to the identity and location of certain items stored in the warehouse. Each of the certain items has optical identifiers thereon. A plurality of markers providing location data indicating their own location are distributed around the warehouse. The system includes a guided vehicle equipped with an optical imaging device. The vehicle travels in the warehouse aisles past the location of one or more certain items and one or more of the markers indicating their own location. The optical imaging device provides electronic data, translatable into images.

### CROSS-REFERENCE TO RELATED APPLICATIONS

This application claims the benefit of priority of U.S. Provisional Application No. 60/657,661 filed on Mar. 1, 2005, the entire disclosure of which is hereby incorporated by reference as if set forth at length herein. This application also contains subject matter that relates to U.S. Pat. No. 6,801,245, the entire disclosure of which is hereby incorporated by reference as if set forth at length herein.

### STATEMENT REGARDING FEDERALLY SPONSORED RESEARCH OR DEVELOPMENT

Not applicable

### REFERENCE OF A “MICROFICHE APPENDIX”

Not applicable

### BACKGROUND OF THE INVENTION

1. Field of Invention

The present invention relates to systems of and methods for generating and organizing warehouse databases and using the database to provide and/or present required information.

2. Description of the Prior Art

Items stored in warehouses may be kept in defined locations which are at least partially visible from a path adjacent the location. The items themselves can be provided with identifying indicia such as with a one or two dimensional barcode or other optical identifier.

In modern warehouses a database is kept which stores information about items being stored and the location of the items. This information may include column number and shelf number were the item is stored or any other information for locating the items.

The information regarding the location of the item can be stored when the item is received and put in that particular location or by designating locations for different types of items or any other way of having the ability to retrieve the item from the warehouse.

When there is a mismatch between the location designated in the database and actual location of the item it is hard to locate the item, it takes longer to find the item and sometimes it may be considered as a lost item In order to prevent losses caused by misplaced items some of the companies are using employees to scan the items in the warehouse to determine and/or verify the location of the items.

U.S. Pat. No. 6,550,674 discloses a system of generating a database using a moving cart which can have an optical reader and computer thereon for transmission of data to a computer for generating a database.

### BRIEF DESCRIPTION OF THE DRAWINGS

Exemplary embodiments of the present invention will now be briefly described with reference to the following drawing:

FIG. 1 depicts a of a cart having a computer and an optical reader thereon used in the present invention;

FIG. 2 shows a side view of warehouse shelves with items thereon which are operated on in accordance with the present invention;

FIG. 3 shows a data structure usable in the present invention and a database it is stored in;

FIG. 4A-4C are screen shoots provided by the present invention; and

FIG. 5 is a top view of the shelf in FIG. 2 along with other shelves showing the aisle of the warehouse and a guided vehicle in an aisle.

### SUMMARY OF THE INVENTION

The aspects, features and advantages of the present invention will become better understood with regard to the following description with reference to the accompanying drawing(s). What follows are preferred embodiments of the present invention. It should be apparent to those skilled in the art that the foregoing is illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto.

In accordance with one embodiment of the present invention a system is provided for generating a warehouse database containing information relating to the identity and location of certain items stored in the warehouse. Each of the certain items has optical identifiers thereon. A plurality of markers providing location data indicating their own location are distributed around the warehouse. The system includes a guided vehicle equipped with an optical imaging device. The vehicle travels in the warehouse past the location of one or more certain items and one or more of the markers indicating their own location. The optical imaging device provides electronic data, translatable into images. The image includes at least one or more of the certain items in the warehouse with the optical identifiers thereon. A device responsive to at least the location data provides physical location data related to the physical location of the one or more of the certain items. The device also associates the electronic data or information derived therefrom with the physical location data to provide associated data. The associated data is stored in the database.

In one embodiment the device for associating is a computer and the information derived from the electronic data is data identifying the one or more of the certain items.

The plurality of markers indicating their own location can be optical identifiers located at fixed locations which in some embodiments are imaged with one or more of the certain items in the warehouse together with the optical identifiers thereon. In such a case the computer may also extract location data from the electronic data. The plurality of markers indicating their own location can also be RFID devices located at fixed locations.

The system can also include a computing device which controls the guided vehicle to travel in the warehouse past the location of the certain items. The computing device can also control the optical imaging device for providing electronic data in order to systematically capture all the items to be scan.

The system may provide that the database also stores the electronic data in a predetermined relationship to the identification data. The system also queries the database to extract desired information there from relating to one or more predetermined items and also may include a display for presenting the information in an efficient way for locating the certain items.

### DETAILED DESCRIPTION OF THE INVENTION

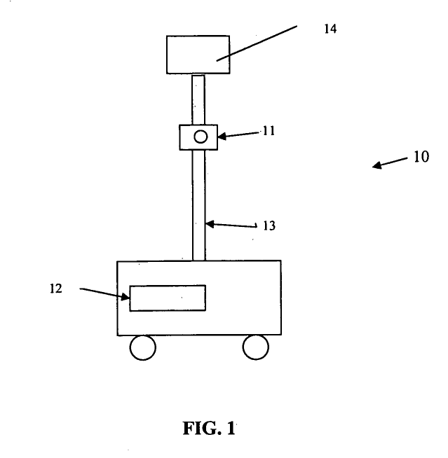

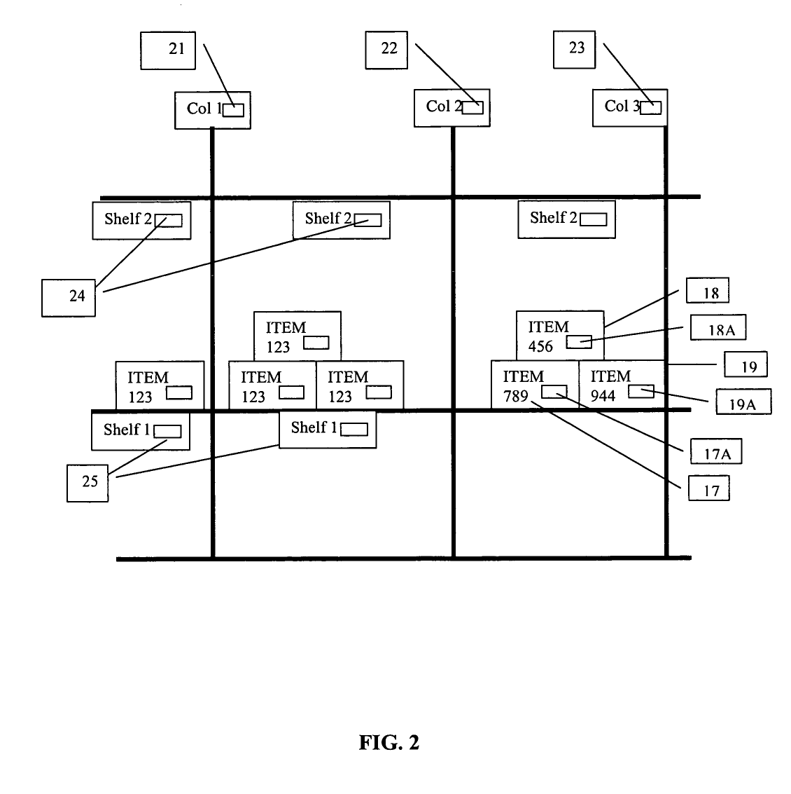

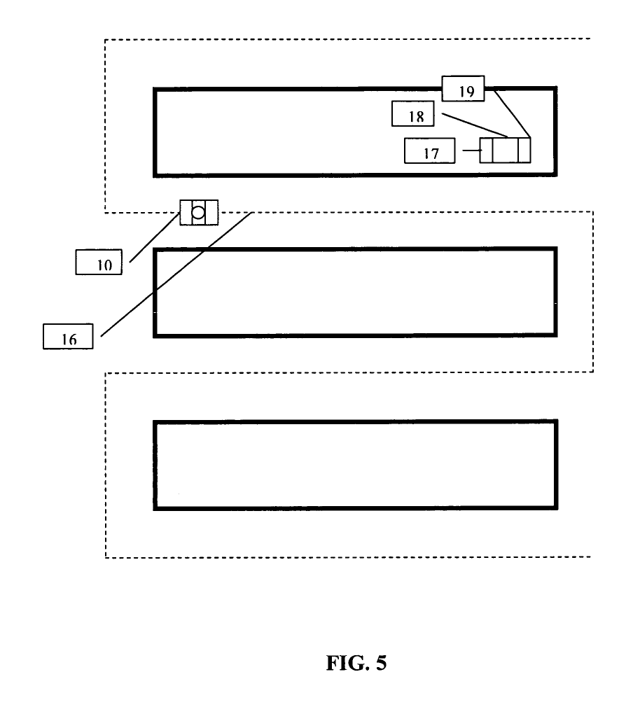

Turning to FIG. 1, the invention includes an automatic guided vehicle 10 equipped with one or more optical devices 11 that can scan the items such as items 17, 18 and 19 shown in FIG. 2, in the warehouse and locate and read barcodes 17a, 18a and 19a such as 2D barcodes or other optical identifiers on the items. The optical device 11 can be one as shown and described in the inventor's U.S. Pat. No. 6,801,245, which is incorporated herein by reference. The vehicle can include a light source such as projector 14. The output of the optical device 11 is an image which can be further processed. The vehicle 10 is made to travel down paths 16 in the warehouse, see FIGS. 2 and 5 to allow the optical device 111 to capture images of the items 17, 18 and 19 and their barcodes 17a, 18a and 19a or other optical identifiers. The image in one embodiment also includes location markers 23 and 25.

The vehicle 10 can be manually driven by an operator or can be automatic e.g. going in a programmed way or guided by magnetic stripes on the floor or any other suitable way to guide the vehicle.

The association of the items in the warehouse to the physical location in the warehouse can be done by knowing the location of the vehicle 10 or by adding identifying information to the physical locations in the warehouse such as adding optical symbols such as two dimensional barcode or other optical identifiers or radio frequency identifiers (rfid) identifying the shelves or the storage locations. See FIG. 2, column identifiers 21, 22 and 23 and shelf identifiers 24 and 25. In this embodiment it would take two identifiers to locate the position of an item such as 17 because there is a column and a shelf to identify. It is also possible to put unique identifiers on each shelf and use only one identifier to identify position.

A computer 12 will control the one or more devices 11 in order to systematically capture all the items to be scan. The locations where items are to be found can be set in advance and when the vehicle 10 is approaching these locations the device 11 may be activated. The items can be scanned by capturing every X feet or every Y sec so that images cover the desired area. Information within the image can also be used to adjust the capturing of the items this information can be a code that will adjust the system to use higher resolution in that location, move faster, turn or behave in some other fashion, commands may be associate with the particular scanned item, the system may change resolution, speed, distance or other parameters by identifying an item (for example when arriving to refrigerators use lower resolution for faster scanning).

In order to scan fields of view larger than the field of view of the optical device 11 the system can be equipped with more than one optical devices 11 or with a pan tilt system to aim the device or with a system, which may include a movable device 13, for moving the optical device 11 across the field of view.

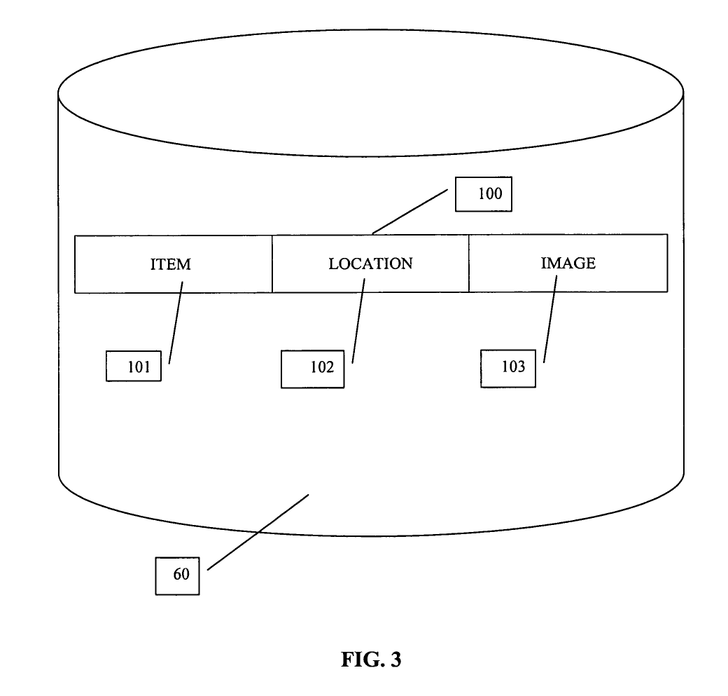

Processing the images from the optical device 11 can be done on the one or more computers 12 on the vehicle and/or by storing all the information which is then transferred to a processing computer system that will process the information or by using wireless networking for transmitting the information for processing or transmitting the processed information. The information may be loaded into a database 60; see FIG. 3.

Referring still to FIG. 3 we see a data structure that can represent the organization of one row in the database 60. The data structure 100 may include field 101 to contain data relating to an item, field 102 to contain data relating to the location of the item and field 103 for storing the data making up the image related to the item or a pointer thereto.

The system may include presentation software, this software will be used for retrieving information regarding a location of an item, the system may show the actual picture of the item or the shelf or the item and the shelf, the picture may include remarks such as an indicator 50 designating the item and warnings such as showing fragile items near the required item.

The presentation software may include logic to find the item which is easier to access than similar items. (e.g. on top of other item and not on bottom so it can more easily removed).

In one embodiment of the invention the database can be queried to extract desired information and such information can be presented in visual form, such as on a computer screen or printed on paper or the like.

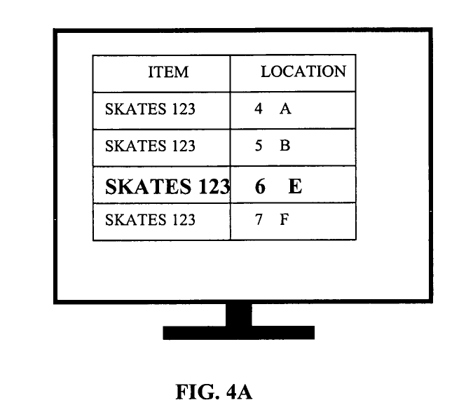

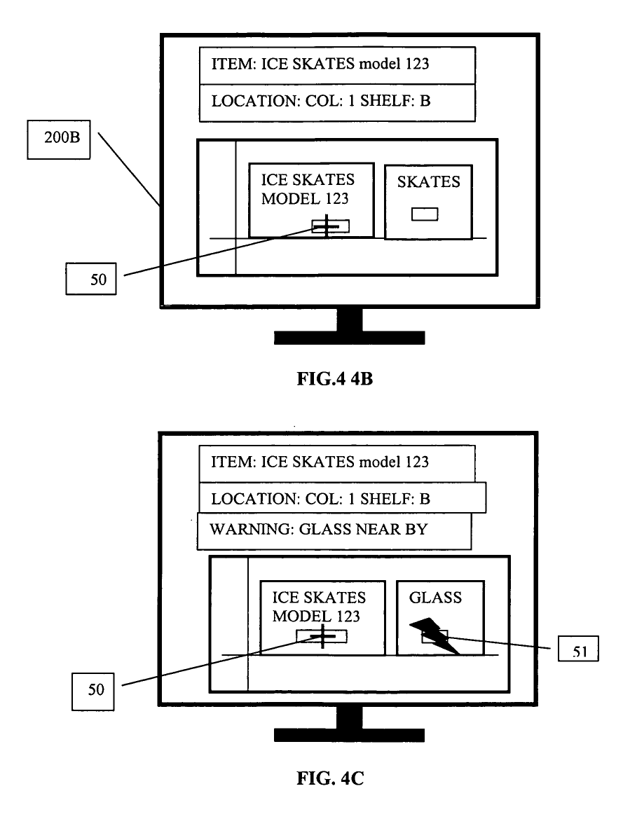

FIGS. 4A-4C show screen shots of presentations which can be made in accordance with various embodiments of this invention. FIG. 4A shows a screen shot 200a which presents a list of similar requested items associated with their respective locations in the warehouse. One of the items is presented in larger type and is bolded to indicate that it is the most accessible of this item. In another embodiment, not shown, the items can be listed in the order of the easiest one to retrieve first and the order is arrange by the difficulty of retrieving.

FIG. 4B shows a screen shot 200b of another presentation which can be made in accordance with this invention. In this embodiment the screen shot shows the picture of a desired item on the shelf in the warehouse and shows in text the name of the item and its location. In this instance there is more than one item in the image so the desired one is marked with a cross 50.

FIG. 4C shows a screen shot similar to the screen shot in FIG. 4B except that the image shows a glass item next to the ice skates and additional text is added indicating that Glass is nearby and the glass item is marked with warning mark 51.

In this invention warehouse is referring to any location with many different items. Different items are referring to different items or identical items with differences such as serial number, manufacturing date, expiration date, color and any other differentiation.

Having now described one or more exemplary embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

For example, the techniques may be implemented in hardware or software, or a combination of the two. In one embodiment, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program may be implemented in a high level procedural or object oriented programming language to communicate with a computer system, however, the programs can be implemented in assembly or machine language, if desired. In any case, the language may be a compiled or interpreted language.

Each such computer program may be stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

What is claimed is:

1. A system for generating a warehouse database containing information relating to the identity and location of certain items stored in the warehouse; each of the certain items having optical identifiers thereon; the system including:
a plurality of markers providing location data indicating their own location distributed around the warehouse;
a guided vehicle equipped with an optical imaging device for traveling in the warehouse past the location of one or more certain items and one or more of the markers indicating their own location; the optical imaging device providing electronic data, translatable into images including at least one or more of the certain items in the warehouse with the optical identifiers thereon;
a device responsive to at least the location data to provide physical location data related to the physical location of the one or more of the certain items; the device also associating the electronic data or information derived there from with the physical location data to provide associated data; and
the associated data is stored in the database.

2. The system as defined in claim 1 in which the device for associating is a computer and the information derived from the electronic data is data identifying the one or more of the certain items.

3. The system as defined in claim 1 in which the plurality markers indicating their own location are optical identifiers.

4. The system as defined in claim 3 in which at least one of the plurality of markers indicating their own location is imaged with one or more of the certain items in the warehouse together with the optical identifiers thereon.

5. The system as defined in claim 4 in which the computer extracts location data from the electronic data.

6. The system as defined in claim 1 in which the plurality of markers indicating their own location are RFID devices.

7. The system as defined in claim 1 also including:
a computing device which controls the guided vehicle to travel in the warehouse past the locations of the certain items.

8. The system as defined in claim 6 in which the computing device also controls the optical imaging device for providing electronic data in order to systematically capture all the items to be scan.

9. The system as defined in claim 7 in which the locations where the certain items are to be found are programmed into the computing device and when the guided vehicle approaches the locations the optical imaging device is activated by the computing device.

10. The system as defined in claim 8 wherein information extracted from the electronic data is used to adjust the capturing of one or more of the certain items.

11. The system as defined in claim 8 wherein information extracted from the electronic data is used to control the guided vehicle.

12. The system as defined in claim 1 also including:
a movable device on the guided vehicle; and
the optical device is mounted on the movable device for moving the optical device to change the optical devices field of view.

13. The system as defined in claim 2 in which the database also stores the electronic data in a predetermined relationship to the identification data.

14. The system as defined in claim 2 in which database is queried to extract desired information there from relating to one or more predetermined items and also including a display for presenting the information.

15. The system as defined in claim 13 in which the display includes the one or more of the certain items.

16. The system as defined in claim 14 in which the display includes remarks concerning the one or more of the certain items.
